(19) United States
(12) Patent Application Publication
(10) Pub. No.: US 2019/0258914 A1
(43) Pub. Date: Aug. 22, 2019

(54) MEMORY CARD

(71) Applicant: TOSHIBA MEMORY CORPORATION, Tokyo (JP)

(72) Inventors: Hitomi TANAKA, Ota Tokyo (JP); Kuniaki Ito, Funabashi Chiba (JP)

(21) Appl. No.: 16/111,279

(22) Filed: Aug. 24, 2018

(30) Foreign Application Priority Data
Feb. 19, 2018 (JP) 2018-026940

(51) Int. Cl. G06K 19/077; H04W 4/80; G06F 13/38

(52) U.S. Cl. CPC G06K 19/07767; G06K 19/07732; G06F 13/387; H04W 4/80

(57) ABSTRACT

A memory card includes an interface connectable to a host device, a nonvolatile memory, a memory controller controlling the nonvolatile memory, an antenna for radio communication with a first communication device using a first communication system and for radio communication with a second communication device using a second communication system different from the first communication system, a first communication controller configured to control the radio communication of the antenna using the first communication system, and a second communication controller configured to control the radio communication of the antenna using the second communication system. The first communication controller and the second communication controller preferentially execute the radio communication using the antenna via the second communication system over the radio communication using the antenna via the first communication system.

### CROSS-REFERENCE TO RELATED APPLICATION

This application is based upon and claims the benefit of priority from Japanese Patent Application No. 2018-026940, filed Feb. 19, 2018, the entire contents of which are incorporated herein by reference.

### FIELD

An embodiment described herein relates generally to a memory card.

### BACKGROUND

Memory devices that can perform wired communication and wireless communication have been proposed. One example of such memory devices includes a memory card such as an SD memory card.

### DESCRIPTION OF THE DRAWINGS

FIG. 1 is a block diagram illustrating an SD memory card according to an embodiment;

FIG. 2 is a diagram illustrating signal pins of an SD interface of the SD memory card according to the embodiment;

FIG. 3 is a diagram illustrating SD extension commands issued to the SD memory card according to the embodiment;

FIG. 4 is a block diagram illustrating a first communication controller and a second communication controller of the SD memory card according to the embodiment;

FIG. 5 is a timing chart illustrating radio communication using a second communication system in the second communication controller of the SD memory card according to the embodiment;

FIG. 6 is a diagram illustrating an antenna connection operation of the first communication controller and the second communication controller of the SD memory card according to the embodiment;

FIG. 7 is a diagram illustrating another antenna connection operation of the first communication controller and the second communication controller of the SD memory card according to the embodiment;

FIG. 8 is a diagram illustrating another antenna connection operation of the first communication controller and the second communication controller of the SD memory card according to the embodiment;

FIG. 9 is a diagram illustrating an antenna connection sequence of the first communication controller and the second communication controller of the SD memory card according to the embodiment;

FIG. 10 is a diagram illustrating a first example of an SD extension command sequence of BLE communication in the SD memory card according to the embodiment;

FIG. 11 is a diagram illustrating a second example of the SD extension command sequence of the BLE communication in the SD memory card according to the embodiment;

FIG. 12 is a diagram illustrating a first application example of the SD memory card according to the embodiment;

FIG. 13 is a diagram illustrating a second application example of the SD memory card according to the embodiment; and

FIG. 14 is a diagram illustrating a third application example of the SD memory card according to the embodiment.

### DETAILED DESCRIPTION

An embodiment provides a memory card to improve convenience.

An embodiment provides a memory card comprising an interface connectable to a host device, a nonvolatile memory, a memory controller for the nonvolatile memory, an antenna for radio communication with a first communication device via a first communication system and for radio communication with a second communication device via a second communication system different from the first communication system, a first communication controller configured to control the radio communication via the first communication system, and a second communication controller configured to control the radio communication via the second communication system. The first communication controller and the second communication controller preferentially operate the antenna with the second communication system rather than with the first communication system.

Hereinafter, an embodiment will be described with reference to the drawings. In the drawings, corresponding elements and the like are given the same reference signs.

### Embodiment

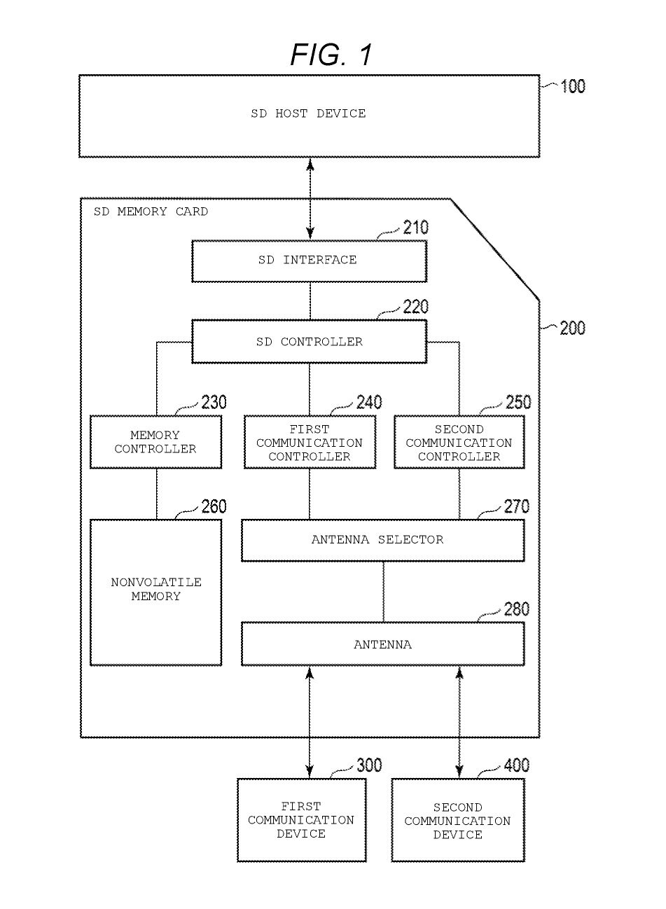

Hereinafter, a memory card according to an embodiment will be described with reference to FIGS. 1 to 14. Hereinafter, although an SD memory card will be described as a memory card, the memory card is not limited thereto and may be applied with another memory card. In addition, in the following description, “connection” represents not only a direct connection but also a connection via any element unless otherwise particularly specified.

Configuration example of an SD memory card

FIG. 1 is a block diagram illustrating an SD memory card 200 according to an embodiment.

As illustrated in FIG. 1, the SD memory card 200 can be detachably attached to an SD host device 100 and transmits/receives data to/from the SD host device 100. The SD host device 100, for example, is a digital camera or the like. In addition, the SD memory card 200 can communicate with a first communication device 300 and a second communication device 400 using different radio communication systems. Here, an example will be described in which the first communication device 300 is a device that can perform communication using a wireless local area network (WLAN), and the second communication device 400 is a device that can perform communication using Bluetooth® Low Energy (BLE).

The SD memory card 200 has a function of writing data supplied from the SD host device 100, a function of reading data into the SD host device 100, and a radio communication function using the first communication device 300 and the second communication device 400 by using power supplied from the electrically-connected SD host device 100.

The SD memory card 200 includes: an SD interface 210, an SD controller 220; a memory controller 230; a first communication controller 240; a second communication controller 250; a nonvolatile memory 260; an antenna selector 270; and an antenna 280. Such a configuration is an example, and at least one of the memory controller 230, the first communication controller 240, and the second communication controller 250 may be provided in the SD controller 220.

The SD interface 210 can be connected to the SD host device 100 and perform transmission/reception of data between the SD memory card 200 and the SD host device 100 using a communication system of an SD standard. The SD interface 210 includes a plurality of signal pins not illustrated in the drawing, and these signal pins are electrically connected to the SD host device 100.

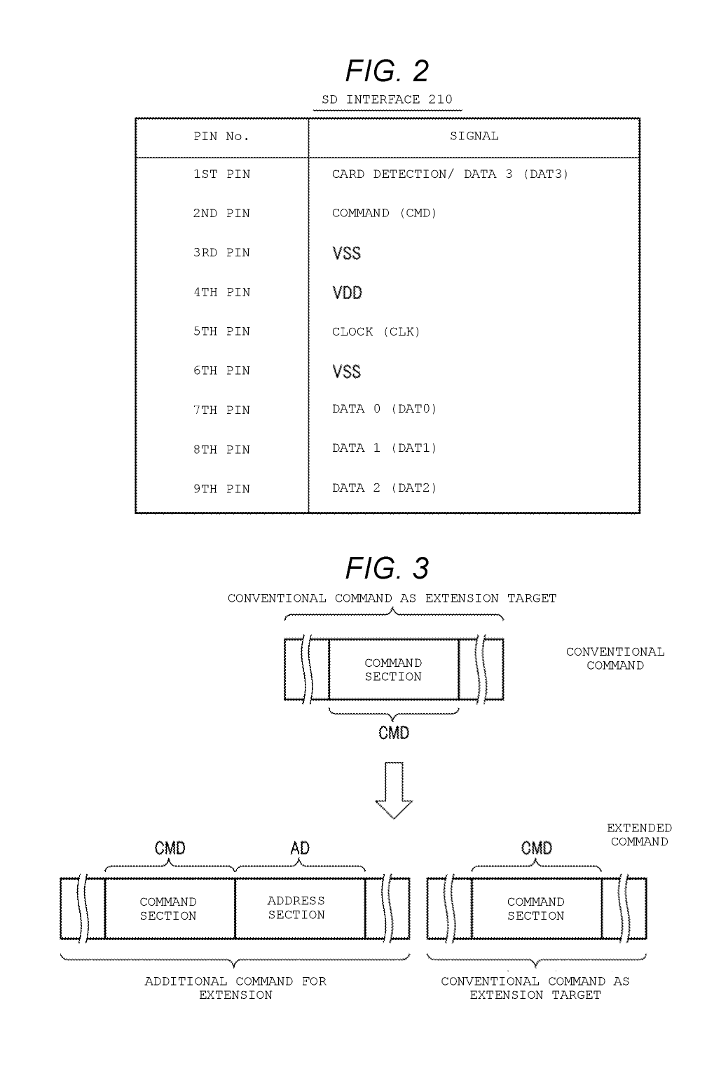

FIG. 2 is a diagram illustrating signal pins of the SD interface 210 of the SD memory card 200.

As illustrated in FIG. 2, the SD interface 210 includes 1st to 9th signal pins. For example, data 0 (DAT0) to data 3 (DAT3) are respectively assigned to the 7th pin, the 8th pin, the 9th, and the 1st pin. In addition, the 1st pin is assigned also with a card detection signal. Furthermore, the 2nd pin is assigned with a command (CMD), the 3rd pin and the 6th pin are assigned with grounding electric potential VSS, the 4th pin is assigned with power source electric potential VDD, and the 5th pin is assigned to a clock signal (CLK).

The SD controller 220 controls the memory controller 230, the first communication controller 240, and the second communication controller 250 according to a command from the SD host device 100. For example, when a write command or a read command of the SD standard are received, the SD controller 220 instructs the memory controller 230 to perform writing or reading of data for the nonvolatile memory 260.

In addition, for example, when an SD extension command used for first communication (e.g., WLAN communication) is received from the SD host device 100, the SD controller 220 gives an instruction relating to communication with the first communication device 300 (for example, instructions such as setting of communication, start of communication, stop of communication, and the like) to the first communication controller 240 by issuing an internal command. In addition, for example, when an SD extension command used for second communication (e.g., BLE communication) is received from the SD host device 100, the SD controller 220 gives an instruction relating to communication with the second communication device 400 to the second communication controller 250 by issuing an internal command.

A communication mode between the SD host device 100 and the SD controller 220, for example, is serial communication such as Inter Integrated Circuit (I2C), Serial Peripheral Interface (SPI), or Universal Asynchronous Receiver/Transmitter (UART). In addition, a communication mode between the SD controller 220 and the first communication controller 240 and the second communication controller 250, for example, is serial communication such as UART.

Here, the SD extension commands are defined in an intelligent SDIO (iSDIO) standard and are commands used for handling functions other than reading and writing of data for the nonvolatile memory 260 in the SD memory card 200.

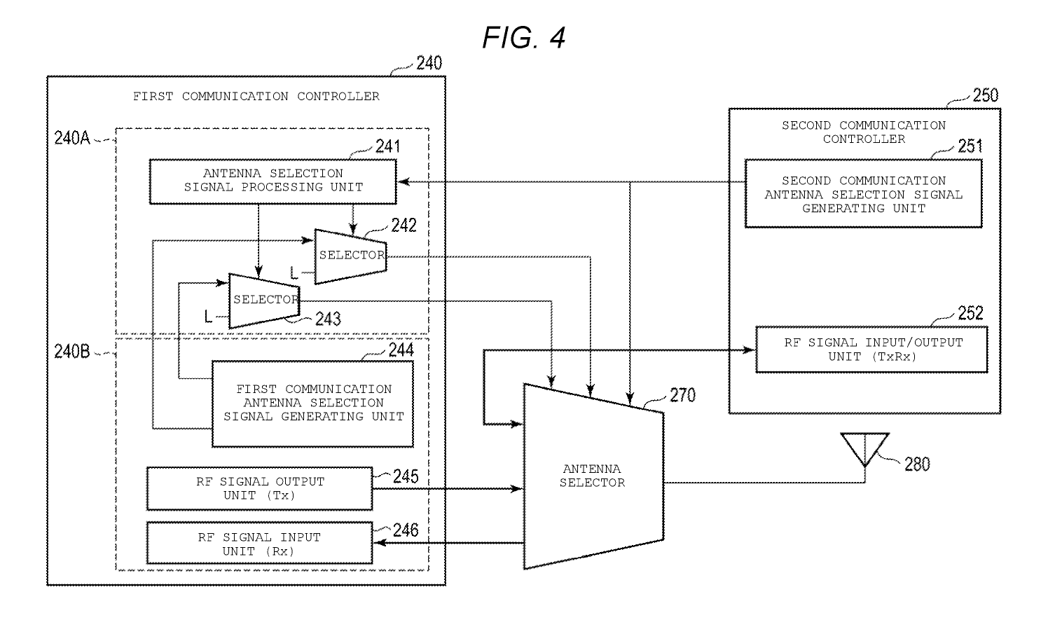

FIG. 3 is a diagram illustrating SD extension commands issued to the SD memory card 200.

As illustrated in FIG. 3, an SD extension command has a configuration in which an additional command for extension is added immediately before a command including a command section CMD (hereinafter, referred to as a conventional command). The additional command for extension includes a command section CMD and an address section AD.

The command section CMD of the additional command for extension, for example, is a command giving an instruction relating to the first communication or the second communication to the SD memory card 200. The address section AD of the additional command for extension represents a device that is a target for radio communication, in other words, an address of the first communication device 300 that is a target for the first communication or an address of the second communication device 400 that is a target for the second communication.

Again, as illustrated in FIG. 1, the memory controller 230 controls the nonvolatile memory 260 according to an instruction from the SD controller 220. For example, in a case in which a write instruction and data are received from the SD controller 220, the memory controller 230 writes the data in the nonvolatile memory 260. In addition, in a case where a read instruction is received from the SD controller 220, the memory controller 230 reads data from the nonvolatile memory 260.

Although the nonvolatile memory 260, for example, is a NAND flash memory, it may be another kind of nonvolatile memory such as a NOR flash memory, a magnetoresistive random access memory (MRAM), a phase change random access memory (PRAM), a resistive random access memory (ReRAM), or a ferroelectric random access memory (FeRAM). In addition, the nonvolatile memory 260, for example, may be a NAND flash memory having a three-dimensional structure. The nonvolatile memory 260 stores data received from the SD host device 100, the first communication device 300, and the second communication device 400.

When an internal command is received from the SD controller 220, the first communication controller 240 executes setting of WLAN communication, start of WLAN communication, stop of WLAN communication, or the like for the first communication device 300.

When an internal command is received from the SD controller 220, the second communication controller 250 executes setting of BLE communication, start of BLE communication, stop of BLE communication, or the like for the second communication device 400.

The antenna selector 270 connects the antenna 280 and the first communication controller 240 or the antenna 280 and the second communication controller 250 according to control of the first communication controller 240 and the second communication controller 250.

The antenna 280 executes radio communication between the first communication controller 240 and the first communication device 300 or radio communication between the second communication controller 250 and the second communication device 400 based on a connection using the antenna selector 270.

Configuration of first communication controller and second communication controller

FIG. 4 is a block diagram illustrating the first communication controller 240 and the second communication controller 250 of the SD memory card 200.

As illustrated in FIG. 4, the first communication controller 240 includes an arbitration processing unit 240A and a communication processing unit 240B. The arbitration processing unit 240A includes an antenna selection signal processing unit 241 and selectors 242 and 243. The communication processing unit 240B includes a first communication antenna selection signal generating unit 244, a radio frequency (RF) signal (high frequency signal) output unit (Tx) 245, and an RF signal input unit (Rx) 246. The second communication controller 250 includes a second communication antenna selection signal generating unit 251 and an RF signal input/output unit (TxRx) 252.

In addition, the RF signal output unit 245 and the RF signal input unit 246 may be configured as one input/output unit, or the RF signal input/output unit 252 may be divided into an input unit and an output unit.

The second communication antenna selection signal generating unit 251 transmits a control signal to the antenna selector 270 and the antenna selection signal processing unit 241. The antenna selection signal processing unit 241 transmits a control signal to the selectors 242 and 243 based on a control signal from the second communication antenna selection signal generating unit 251.

The selector 242 receives a control signal of a low (L) level from an internal circuit not illustrated in the drawing and a transmission (Tx) control signal from the first communication antenna selection signal generating unit 244. Then, the selector 242 selects one of a control signal of the L level transmitted from the internal circuit and a transmission control signal transmitted from the first communication antenna selection signal generating unit 244 based on a control signal transmitted from the antenna selection signal processing unit 241. The selector 242 transmits the selected control signal to the antenna selector 270.

The selector 243 receives a control signal of the L level from the internal circuit and a reception (Rx) control signal from the first communication antenna selection signal generating unit 244. Then, the selector 243 selects one of the control signal of the L level transmitted from the internal circuit and the reception control signal transmitted from the first communication antenna selection signal generating unit 244 based on a control signal transmitted from the antenna selection signal processing unit 241. The selector 243 transmits the selected control signal to the antenna selector 270.

The antenna selector 270 receives an RF signal from the RF signal output unit 245. In addition, the antenna selector 270 transmits an RF signal to the RF signal input unit 246. Furthermore, the antenna selector 270 receives an RF signal from the RF signal input/output unit 252 and transmits an RF signal to the RF signal input/output unit 252. Then, the antenna selector 270 connects one of the RF signal output unit 245, the RF signal input unit 246, and the RF signal input/output unit 252 to the antenna 280 based on control signals transmitted from the selectors 242 and 243 and the second communication antenna selection signal generating unit 251. One of the RF signal output unit 245, the RF signal input unit 246, and the RF signal input/output unit 252 that is connected executes radio communication of an RF signal through the antenna 280.

Antenna connection operation of first communication controller and second communication controller

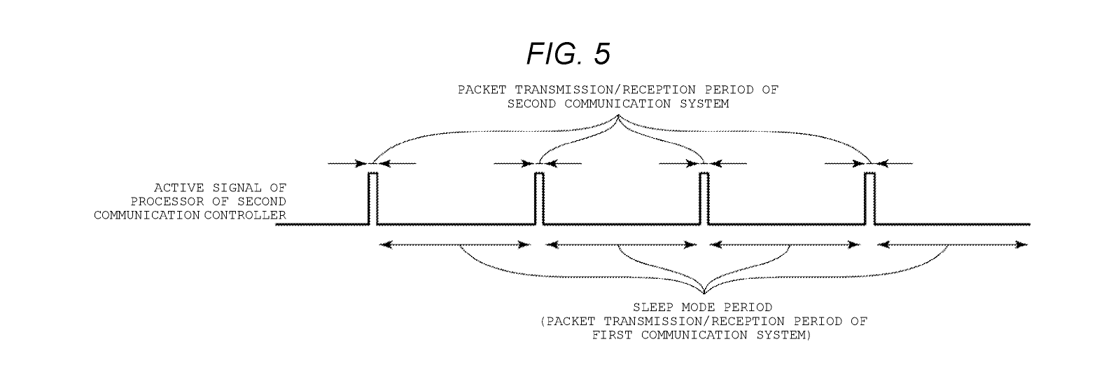

FIG. 5 is a timing chart illustrating radio communication (BLE communication) using the second communication system in the second communication controller 250 of the SD memory card 200.

As illustrated in FIG. 5, an active signal of a processor, which is not illustrated in the drawing, of the second communication controller 250 is regularly asserted (becomes a high (H) level). This active signal corresponds to a control signal transmitted from the second communication antenna selection signal generating unit 251 illustrated in FIG. 4. The second communication controller 250 transmits/receives packets to/from the second communication device 400 using the second communication system in a period in which the active signal of the processor is asserted. In other words, radio communication using the second communication system is a frequency hopping system and is executed in a predetermined period set in advance.

On the other hand, the second communication controller 250 is in a sleep mode in a period in which an active signal of the processor is negated (becomes the L level). In any period in the sleep mode period of the second communication controller 250, the first communication controller 240 transmits/receives packets to/from the first communication device 300 using the first communication system. In other words, the radio communication (WLAN) using the first communication system is a carrier sense multiple access (CSMA) system and is executed in any period.

Hereinafter, an antenna connection operation using the first communication controller 240 and the second communication controller 250 will be described.

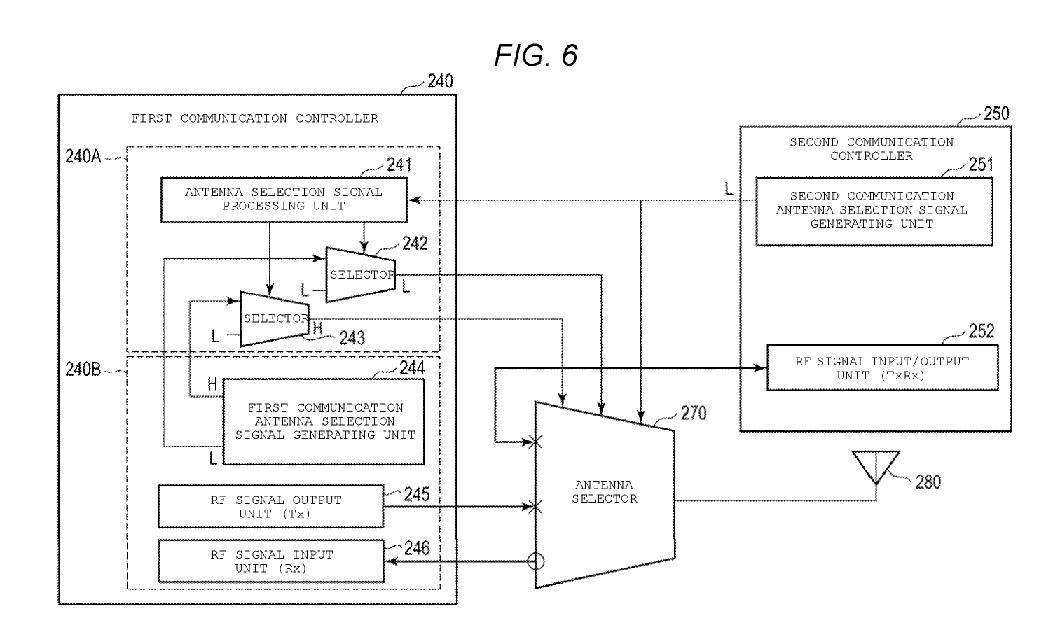

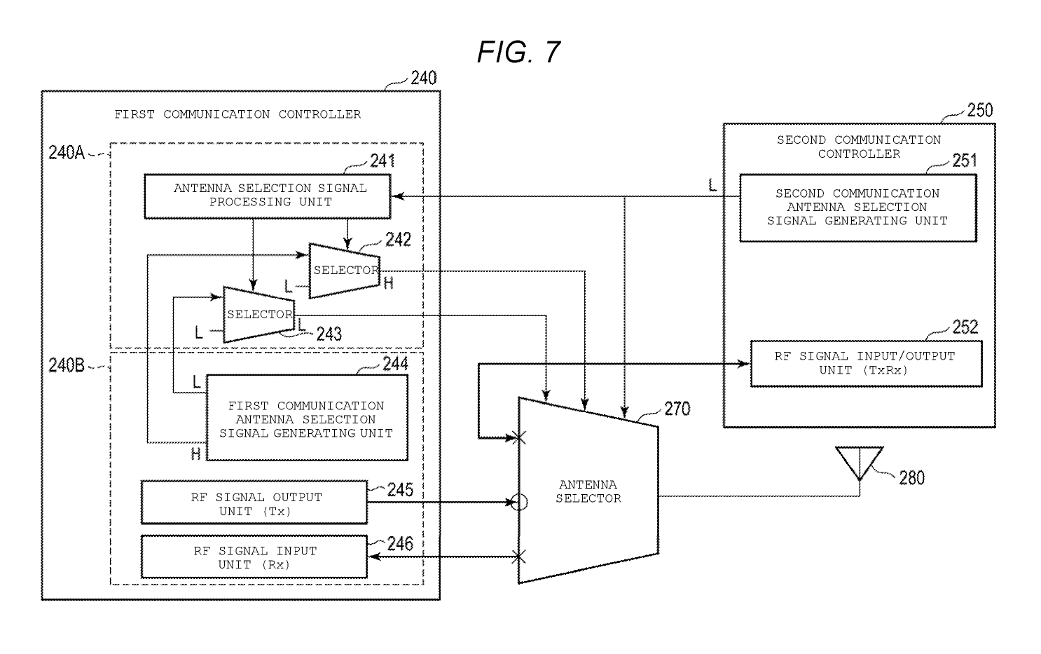

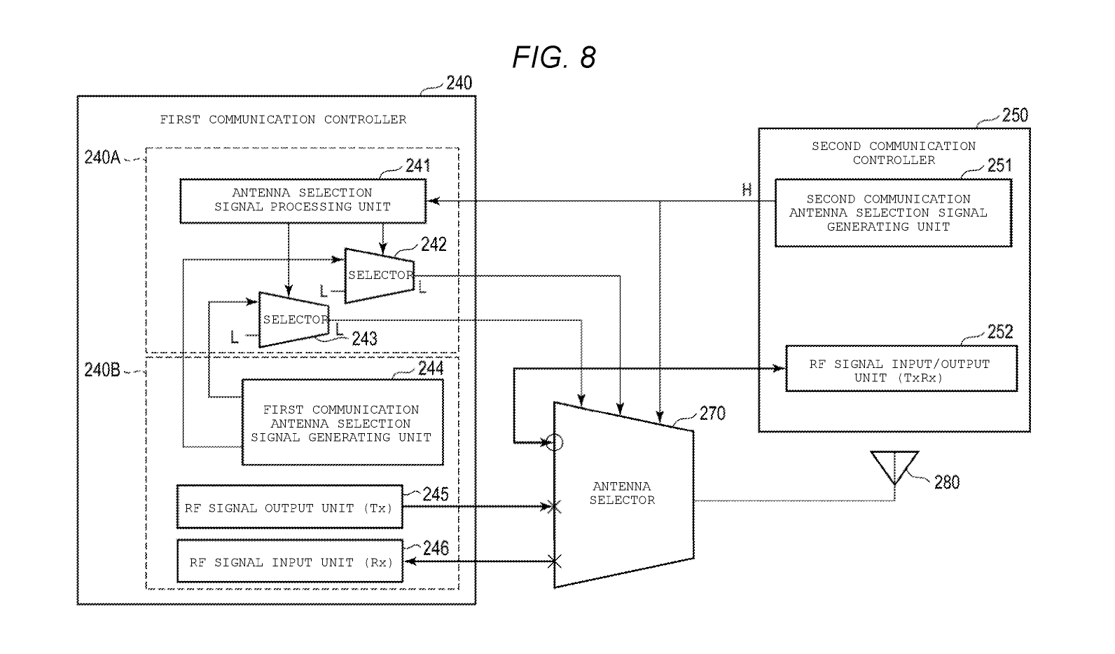

FIGS. 6 to 8 are diagrams illustrating an antenna connection operation of the first communication controller 240 and the second communication controller 250 of the SD memory card 200. More specifically, FIG. 6 is a diagram illustrating an antenna connection at the time of a reception operation (e.g., a reception operation using the WLAN) of packets using the first communication controller 240, FIG. 7 is a diagram illustrating an antenna connection at the time of a transmission operation (e.g., a transmission operation using the WLAN) of packets using the first communication controller 240, and FIG. 8 is a diagram illustrating an antenna connection at the time of a transmission/reception operation (e.g., a transmission/reception operation using the BLE) of packets using the second communication controller 250.

In this example, radio communication using the first communication system and radio communication using the second communication system are executed in a time divisional manner using one antenna 280. In other words, when the radio communication using the first communication system is executed, the RF signal output unit 245 or the RF signal input unit 246 and the antenna 280 are connected. On the other hand, when the radio communication using the second communication system is executed, the RF signal input/output unit 252 and the antenna 280 are connected. Here, the radio communication (e.g., BLE communication) using the second communication system executed at regular timings is preferentially executed rather than the radiocommunication (e.g., WLAN communication) using the first communication system executed at any timing. Hereinafter, more detailed descriptions thereof will be presented.

As illustrated in FIG. 6, in a packet reception operation using the first communication controller 240, the second communication antenna selection signal generating unit 251 transmits a control signal of the L level to the antenna selector 270 and the antenna selection signal processing unit 241. On the other hand, the first communication antenna selection signal generating unit 244 transmits a control signal of the L level to the selector 242 and transmits a reception control signal of an H level to the selector 243. The antenna selection signal processing unit 241 transmits a predetermined control signal (for example, a control signal of the L level) to the selectors 242 and 243 according to the control signal of the L level transmitted from the second communication antenna selection signal generating unit 251.

The selectors 242 and 243 unselect the signal of the L level transmitted from the internal circuit and select the control signal transmitted from the first communication antenna selection signal generating unit 244 according to a predetermined control signal transmitted from the antenna selection signal processing unit 241. Then, the selectors 242 and 243 transmit the control signal transmitted from the first communication antenna selection signal generating unit 244 to the antenna selector 270. In other words, the selector 242 transmits the control signal of the L level to the antenna selector 270, and the selector 243 transmits the control signal of the H level to the antenna selector 270.

In this way, the antenna selector 270 connects the RF signal input unit 246 and the antenna 280 according to the control signal of the H level transmitted from the selector 243. Then, the RF signal input unit 246 receives an RF signal through the antenna 280. On the other hand, the antenna selector 270 does not connect (or disconnects) the RF signal input/output unit 252 and the antenna 280 according to the control signal of the L level transmitted from the second communication antenna selection signal generating unit 251. In addition, the antenna selector 270 does not connect the RF signal output unit 245 and the antenna 280 according to the control signal of the L level transmitted from the selector 242. In this way, a packet reception operation using the first communication controller 240 is executed.

As illustrated in FIG. 7, in a packet transmission operation using the first communication controller 240, the second communication antenna selection signal generating unit 251 transmits a control signal of the L level to the antenna selector 270 and the antenna selection signal processing unit 241. On the other hand, the first communication antenna selection signal generating unit 244 transmits a transmission control signal of the H level to the selector 242 and transmits a reception control signal of the L level to the selector 243. The antenna selection signal processing unit 241 transmits a predetermined control signal (for example, a control signal of the L level) to the selectors 242 and 243 according to a control signal of the L level transmitted from the second communication antenna selection signal generating unit 251.

The selectors 242 and 243 unselect a signal of the L level transmitted from the internal circuit and select a control signal transmitted from the first communication antenna selection signal generating unit 244 according to a predetermined control signal transmitted from the antenna selection signal processing unit 241. Then, the selectors 242 and 243 transmit the control signal transmitted from the first communication antenna selection signal generating unit 244 to the antenna selector 270. In other words, the selector 242 transmits the control signal of the H level to the antenna selector 270, and the selector 243 transmits the control signal of the L level to the antenna selector 270.

In this way, the antenna selector 270 connects the RF signal output unit 245 and the antenna 280 according to the control signal of the H level transmitted from the selector 242. Then, the RF signal output unit 245 transmits an RF signal through the antenna 280. On the other hand, the antenna selector 270 does not connect the RF signal input/output unit 252 and the antenna 280 according to the control signal of the L level transmitted from the second communication antenna selection signal generating unit 251. In addition, the antenna selector 270 does not connect the RF signal input unit 246 and the antenna 280 according to the control signal of the L level transmitted from the selector 243. In this way, a packet transmission operation using the first communication controller 240 is executed.

As illustrated in FIG. 8, in a packet transmission/reception operation using the second communication controller 250, the second communication antenna selection signal generating unit 251 transmits the control signal of the H level to the antenna selector 270 and the antenna selection signal processing unit 241. On the other hand, the first communication antenna selection signal generating unit 244 may transmit the transmission control signal of the L level to the selector 242 and transmit the reception control signal of the L level to the selector 243. In addition, the first communication antenna selection signal generating unit 244 may transmit the transmission control signal of the H level to the selector 242 and may transmit the reception control signal of the H level to the selector 243. The antenna selection signal processing unit 241 transmits a predetermined control signal (for example, the control signal of the H level) to the selectors 242 and 243 according to the control signal of the H level transmitted from the second communication antenna selection signal generating unit 251.

Both the selectors 242 and 243 unselect the control signal transmitted from the first communication antenna selection signal generating unit 244 and selects the control signal of the L level transmitted from the internal circuit according to a predetermined control signal transmitted from the antenna selection signal processing unit 241. Then, both the selectors 242 and 243 transmit the control signal of the L level transmitted from the internal circuit to the antenna selector 270.

In this way, the antenna selector 270 connects the RF signal input/output unit 252 and the antenna 280 according to the control signal of the H level transmitted from the second communication antenna selection signal generating unit 251. Then, the RF signal input/output unit 252 transmits and receives an RF signal through the antenna 280. On the other hand, the antenna selector 270 does not connect the RF signal output unit 245 and the antenna 280 according to the control signal of the L level transmitted from the selector 242. In addition, the antenna selector 270 does not connect the RF signal input unit 246 and the antenna 280 according to the control signal of the L level transmitted from the selector 243. In this way, a packet transmission/reception operation using the second communication controller 250 is executed.

Antenna connection sequence of first communication controller and second communication controller

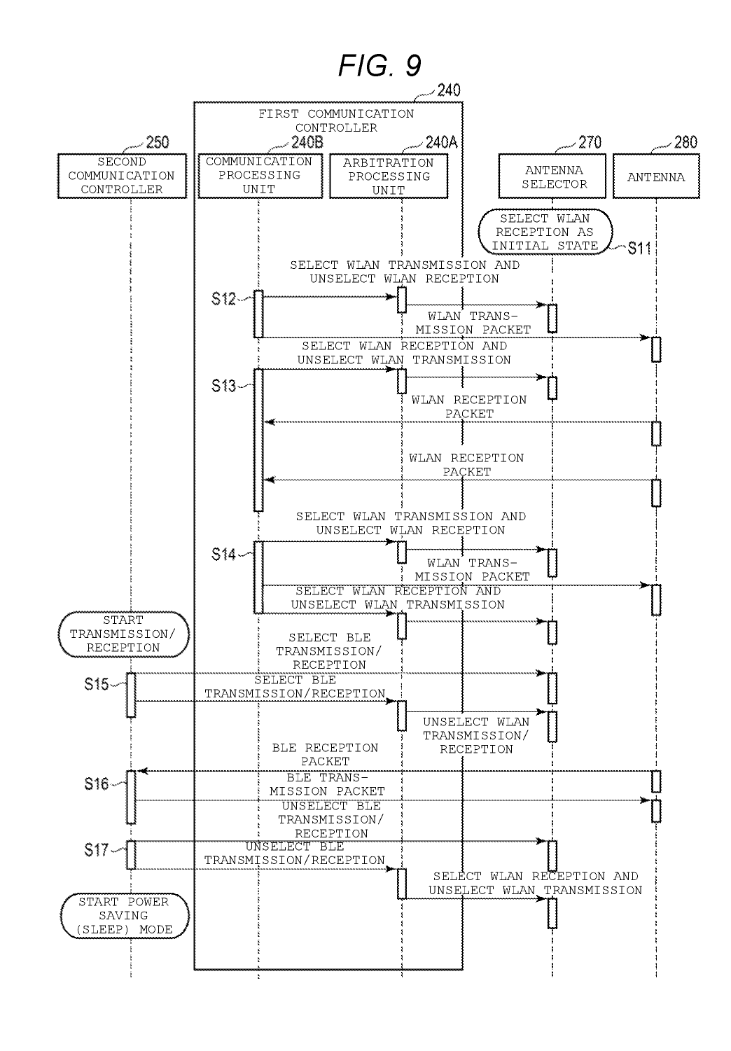

FIG. 9 is a diagram illustrating an antenna connection sequence of the first communication controller 240 and the second communication controller 250 of the SD memory card 200. Here, transmission and reception of information in the first communication controller 240, the second communication controller 250, the antenna selector 270, and the antenna 280 will be described.

As illustrated in FIG. 9, first, in S11, the antenna selector 270 selects packet reception using radio communication (e.g., WLAN communication) of the first communication system as an initial state. In other words, the communication processing unit 240B transmits a control signal (e.g., a reception control signal of the H level) used for selecting WLAN reception and a signal (e.g., a transmission control signal of the L level) used for unselecting WLAN transmission to the arbitration processing unit 240A, and the arbitration processing unit 240A transmits such control signals to the antenna selector 270. Accordingly, the antenna selector 270 connects the RF signal input unit 246 of the communication processing unit 240B and the antenna 280. In addition, in the initial state, the second communication controller 250 may be in a power save mode (e.g., sleep mode) state.

Next, in a case in which a request for transmitting packets using the WLAN is generated, in S12, the communication processing unit 240B transmits a signal (e.g., a transmission control signal of the H level) used for selecting WLAN transmission and a signal (e.g., a reception control signal of the L level) used for unselecting WLAN reception to the arbitration processing unit 240A. The arbitration processing unit 240A transmits the signal received from the communication processing unit 240B to the antenna selector 270. Accordingly, the antenna selector 270 connects the RF signal output unit 245 of the communication processing unit 240B and the antenna 280. Then, the communication processing unit 240B transmits a packet for the WLAN transmission to the antenna 280.

Subsequently, in a case in which a request for transmitting packets using the WLAN is not generated, in S13, the communication processing unit 240B transmits a signal (e.g., a reception control signal of the H level) used for selecting WLAN reception and a signal (e.g., a transmission control signal of the L level) used for unselecting WLAN transmission to the arbitration processing unit 240A. The arbitration processing unit 240A transmits the signal received from the communication processing unit 240B to the antenna selector 270. Accordingly, the antenna selector 270 connects the RF signal input unit 246 of the communication processing unit 240B and the antenna 280. Then, the communication processing unit 240B receives a packet for WLAN reception from the antenna 280.

Thereafter, in a case in which a request for transmitting packets using the WLAN is generated, in S14, an operation similar to that of in S12 is executed. In addition, in a case in which a request for transmitting packets using the WLAN is not generated, in S14, an operation similar to that of in S13 is executed.

Next, when it becomes a timing for starting packet transmission/reception using the radio communication of the second communication system (e.g., BLE communication), the second communication controller 250 is activated. Then, in S15, the second communication controller 250 transmits a signal (e.g., a control signal of the H level) used for selecting BLE transmission/reception to the antenna selector 270.

At this time, the second communication controller 250 transmits a signal used for selecting BLE transmission also to the arbitration processing unit 240A. The arbitration processing unit 240A transmits a signal used for unselecting the WLAN transmission/reception to the antenna selector 270 according to the signal received from the second communication controller 250. Accordingly, the antenna selector 270 connects the RF signal input/output unit 252 of the second communication controller 250 and the antenna 280 and disconnects the RF signal input unit 246 of the communication processing unit 240B and the RF signal output unit 245 from the antenna 280.

Accordingly, a state is formed in which only the antenna 280 and the RF signal input/output unit 252 of the second communication controller 250 are connected. Accordingly, in S16, the second communication controller 250 receives packets for the BLE reception from the antenna 280 and transmits packets for BLE transmission to the antenna 280 for a predetermined period.

Next, when the transmission/reception using the BLE for the predetermined period is completed, in S17, the second communication controller 250 transmits a signal (e.g., a control signal of the L level) used for unselecting the BLE transmission/reception to the antenna selector 270.

At this time, the second communication controller 250 transmits the signal used for unselecting the BLE transmission/reception also to the arbitration processing unit 240A. In a case in which a request for the BLE transmission/reception and the WLAN transmission is not received, the arbitration processing unit 240A selects WLAN reception. Accordingly, the arbitration processing unit 240A, for example, transmits a signal used for selecting the WLAN reception and a signal used for unselecting the WLAN transmission to the antenna selector 270 according to the signal received from the second communication controller 250. Accordingly, the antenna selector 270 disconnects the RF signal input/output unit 252 of the second communication controller 250 from the antenna 280 and sets the same state as the initial state, in other words, connects the RF signal input unit 246 of the communication processing unit 240B and the antenna 280.

Thereafter, the second communication controller 250 is in the power save mode (e.g., sleep mode) and appropriately executes reception or transmission of packets using the WLAN in response to a request.

As described above, the SD memory card 200 preferentially executes the BLE communication rather than the WLAN communication. For this reason, the state of being in the middle of packet transmission/reception using the BLE may be recorded in a register not illustrated in the drawing. In a case in which a request for transmitting packets using the WLAN is generated, the first communication controller 240 refers to the register. In a case in which the state of being in the middle of transmission/reception using the BLE is determined based on a result of referring to the register, the first communication controller 240 waits for packet transmission using the WLAN. Then, after packet transmission/reception using the BLE, the first communication controller 240 executes packet transmission using the WLAN.

In addition, in a case in which packet transmission/reception using the BLE is started in the middle of packet transmission/reception using the WLAN, packet communication using the WLAN that is in the middle of transmission or reception fails.

In addition, when packet transmission/reception of one time using the BLE is completed, subsequent packet transmission/reception using the BLE is executed at a timing at which next transmission/reception using the BLE can be executed. In other words, in one asserting period of a processor active signal illustrated in FIG. 5, packet transmission/reception of one time using the BLE is executed.

SD extension command sequence in BLE communication

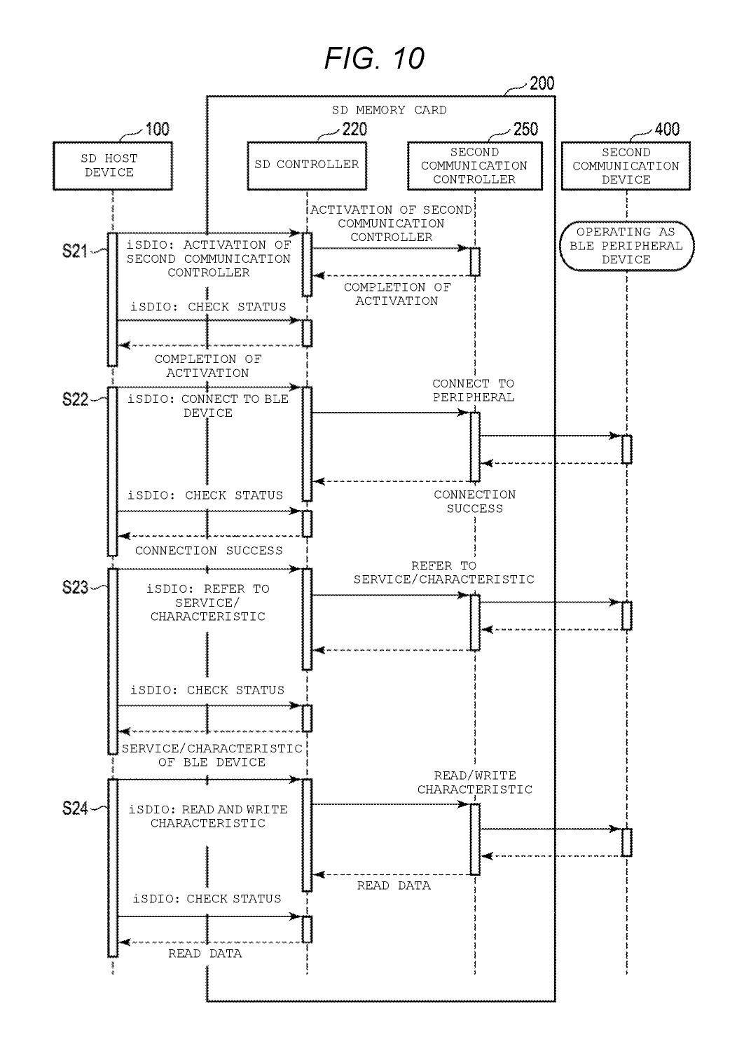

FIG. 10 is a diagram illustrating a first example of an SD extension command sequence of BLE communication in the SD memory card 200. Here, transmission/reception of information in the SD host device 100, the SD memory card 200, and the second communication device 400 will be described.

In addition, the first example illustrated in FIG. 10 illustrates an example in which the SD memory card 200 operates as a central device of BLE communication, and the second communication device 400 operates as a peripheral device of the BLE communication. The central device represents a device that searches for a peripheral device, is connected to the peripheral device, and independently executes communication for the peripheral device. In addition, the peripheral device represents a device that accepts a connection from the outside (central device) and passively executes communication.

As illustrated in FIG. 10, first, in S21, the SD host device 100 issues an SD extension command (iSDIO) for activating of the second communication controller 250 and transmits the SD extension command to the SD controller 220. The SD controller 220 issues an internal command based on the SD extension command and transmits the internal command to the second communication controller 250. When the activation is completed, the second communication controller 250 transmits an activation completion response to the SD controller 220.

Next, the SD host device 100 issues an SD extension command used for checking the status of the SD memory card 200 and transmits the SD extension command to the SD controller 220. The SD controller 220 transmits the activation completion response of the second communication controller 250 to the SD host device 100 according to the SD extension command.

Next, in S22, the SD host device 100 issues an SD extension command used for designating an address of an external BLE device (e.g., second communication device 400), making a connection thereto and transmits the SD extension command to the SD controller 220. The SD controller 220 issues an internal command based on the SD extension command and transmits the internal command to the second communication controller 250. By using this internal command, the second communication controller 250 makes a connection to the second communication device 400 as a peripheral device. In a case in which the connection is successful, the second communication device 400 transmits a connection success response to the second communication controller 250. Then, the second communication controller 250 transmits the connection success response transmitted from the second communication device 400 to the SD controller 220.

Next, the SD host device 100 issues an SD extension command used for checking the status of the SD memory card 200 and transmits the SD extension command to the SD controller 220. The SD controller 220 transmits the connection success response of the second communication controller 250 to the SD host device 100 according to the SD extension command.

Next, in S23, the SD host device 100 issues an SD extension command used for referring to services and characteristics of the second communication device 400 and transmits the SD extension command to the SD controller 220. The SD controller 220 issues an internal command based on the SD extension command and transmits the internal command to the second communication controller 250. By using this internal command, the second communication controller 250 refers to the services and the characteristics of the second communication device 400. Then, the second communication controller 250 transmits the referred services and characteristics of the second communication device 400 to the SD controller 220.

Here, the services represent functions of the second communication device 400. Examples of the services include a service of a thermometer, a service of a global positioning system (GPS), and the like. In addition, the characteristics represent specific data present in each service. Examples of the characteristics include latitude data and longitude data in a service of a GPS and the like.

Next, the SD host device 100 issues an SD extension command for checking the status of the SD memory card 200 and transmits the SD extension command to the SD controller 220. The SD controller 220 transmits the services and the characteristics of the second communication device 400 to the SD host device 100 according to the SD extension command.

By using the process up to here, the SD host device 100 can check functions and data included in the second communication device 400. At this time, actual data is not yet received by the SD host device 100 from the second communication device 400.

Next, in S24, the SD host device 100 issues an SD extension command used for reading and writing data of the services and the characteristics of the second communication device 400 and transmits the SD extension command to the SD controller 220. The SD controller 220 issues an internal command based on the SD extension command and transmits the internal command to the second communication controller 250. According to this internal command, the second communication controller 250 reads the data of the services and the characteristics of the second communication device 400. Then, the second communication controller 250 transmits the read data of the services and the characteristics of the second communication device 400 to the SD controller 220. The SD controller 220 writes the data of the services and the characteristics of the second communication device 400 transmitted from the second communication controller 250 in the nonvolatile memory 260.

Next, the SD host device 100 issues an SD extension command used for checking the status of the SD memory card 200 and transmits the SD extension command to the SD controller 220. The SD controller 220 transmits the data of the services and the characteristics of the second communication device 400 to the SD host device 100 according to the SD extension command.

In this way, BLE communication in which the SD memory card 200 is set as a central device, and the second communication device 400 is set as a peripheral device is executed.

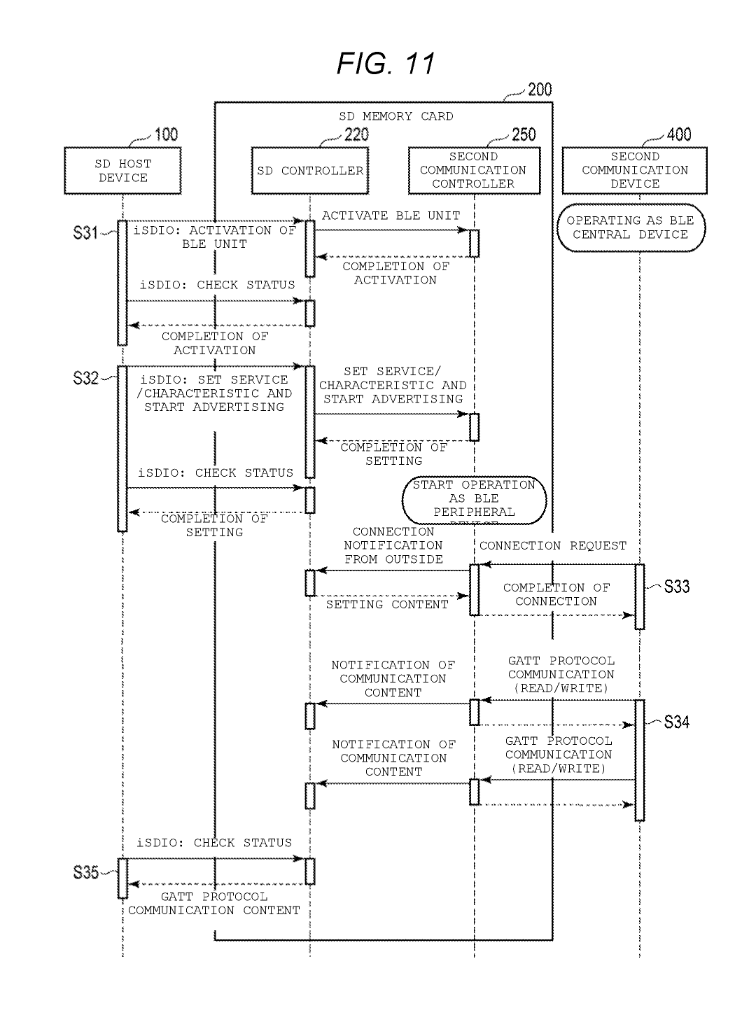

FIG. 11 is a diagram illustrating a second example of an SD extension command sequence of BLE communication in the SD memory card 200. Here, transmission/reception of information in the SD host device 100, the SD memory card 200, and the second communication device 400 will be described.

In addition, the second example illustrated in FIG. 11 illustrates an example in which the SD memory card 200 operates as a peripheral device of BLE communication, and the second communication device 400 operates as a central device of the BLE communication.

As illustrated in FIG. 11, first, in S31, the SD host device 100 issues an SD extension command for activating the second communication controller 250 and transmits the SD extension command to the SD controller 220. The SD controller 220 issues an internal command based on the SD extension command and transmits the internal command to the second communication controller 250. When the activation is completed, the second communication controller 250 transmits an activation completion response to the SD controller 220.

Next, the SD host device 100 issues an SD extension command used for checking the status of the SD memory card 200 and transmits the SD extension command to the SD controller 220. The SD controller 220 transmits the activation completion response of the second communication controller 250 to the SD host device 100 according to the SD extension command.

Next, in S32, the SD host device 100 issues an SD extension command used for starting advertising with a service and a characteristic set. The SD host device 100 transmits the SD extension command to the SD controller 220. The SD controller 220 issues an internal command based on the SD extension command and transmits the internal command to the second communication controller 250. According to this internal command, the second communication controller 250 sets the service and the characteristics, and read data and/or write data is set with respect to a connection destination in the BLE communication. Then, the second communication controller 250 starts advertising. In addition, when the setting is completed, the second communication controller 250 transmits a setting completion response to the SD controller 220.

Here, advertising represents regularly transmitting a packet from the SD memory card 200 to the second communication device 400 such that a peripheral device (here, the SD memory card 200) of the BLE communication finds the central device (here, the second communication device 400) of the BLE communication. On the other hand, the second communication device 400 finds a peripheral device of the BLE communication using an operation called scanning.

Next, the SD host device 100 issues an SD extension command used for checking the status of the SD memory card 200 and transmits the SD extension command to the SD controller 220. The SD controller 220 transmits a setting completion response of the second communication controller 250 to the SD host device 100 according to the SD extension command. According to this, the second communication controller 250 starts the operation as a BLE peripheral device.

Next, in S33, when a connection request for a connection with the SD memory card 200 is received from the outside, the second communication device 400 transmits the connection request for a connection with the SD memory card 200 to the second communication controller 250. The second communication controller 250 transmits a connection notification from the outside to the SD controller 220 in response to the connection request. The SD controller 220 transmits a setting content of data to the second communication controller 250 according to the connection notification. When the connection between the SD memory card 200 and the second communication device 400 is completed, the second communication controller 250 transmits a connection completion response to the second communication device 400.

Thereafter, in S34, the second communication device 400 executes generic attribute (GATT) protocol communication for the second communication controller 250. The GATT is a standard data format in the BLE communication. According to this, the second communication device 400 reads data through the second communication controller 250 or writes data through the second communication controller 250. The second communication controller 250 notifies the SD controller 250 of the communication content from the second communication device 400.

Next, in S35, the SD host device 100 issues an SD extension command used for checking the status of the SD memory card 200 and transmits the SD extension command to the SD controller 220. The SD controller 220 transmits a GATT protocol communication content (an update content of data or the like) from the second communication device 400 to the SD host device 100 according to the SD extension command.

In this way, the BLE communication is executed in which the SD memory card 200 is set as a peripheral device, and the second communication device 400 is set as a central device.

### APPLICATION EXAMPLE

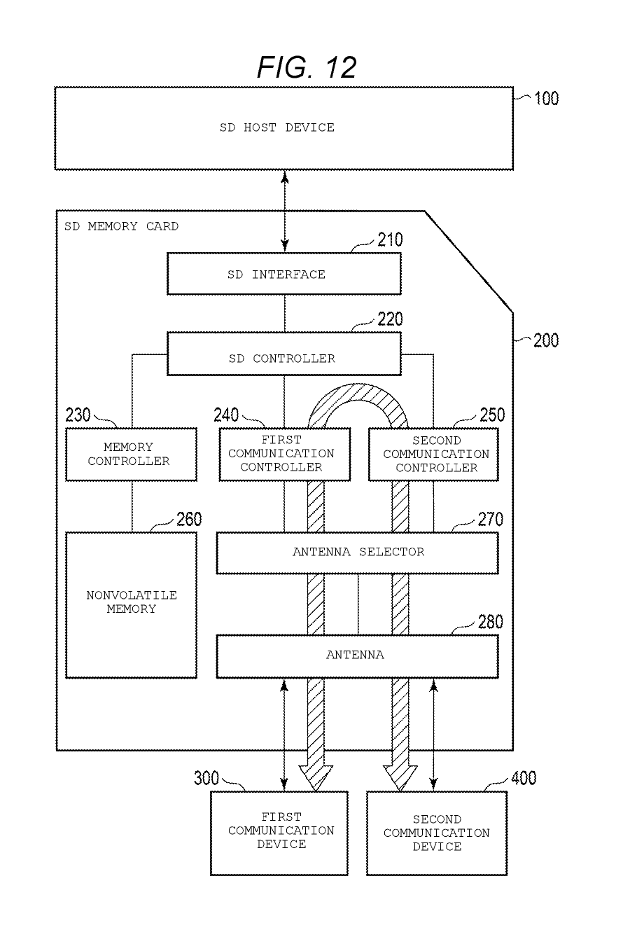

FIG. 12 is a diagram illustrating a first application example of the SD memory card 200. In the first application example, the SD memory card 200 functions as a relay device among a plurality of networks. In other words, the SD memory card 200 functions as a bridge or a gateway.

As illustrated in FIG. 12, in the first application example, the SD memory card 200 is connected to a first communication device 300 using WLAN communication and is connected to a second communication device 400 using BLE communication. The first communication device 300, for example, may be connected to a higher-rank network such as a wide area network (WAN), and the second communication device 400 may execute communication using a protocol having compatibility with other networks such as an ipv6 Low-energy on Wireless Personal Area Network (6LoWPAN).

The SD controller 220 of the SD memory card 200 includes an information processing unit not illustrated in the drawing, and the information processing unit analyzes data received from a network. Accordingly, the SD controller 220 can directly transmit data received from the network to another network or can analyze the content of data received from the network, supplement necessary information, and transmit resultant data to another network.

For example, the second communication device 400 transmits a packet having compatibility with a higher-rank network such as a WAN to the SD memory card 200. The SD memory card 200 transmits the packet received from the second communication device 400 to the first communication device 300. More specifically, a packet received from the second communication device 400 is transmitted to the SD controller 220 through the antenna 280 and the second communication controller 250 and thereafter, is transmitted to the first communication device 300 through the first communication controller 240 and the antenna 280. Then, the first communication device 300 transmits the packet received from the SD memory card 200 to a higher-rank network such as a WAN.

In addition, for example, the first communication device 300 transmits a packet received from a higher-rank network such as a WAN to the SD memory card 200. The SD memory card 200 (SD controller 220) analyzes the content of the packet received from the first communication device 300. The SD memory card 200 issues an internal command using a program read from the content of the packet and transmits the internal command to the second communication device 400. The second communication device 400 appropriately operates according to the internal command.

In addition, in a case in which relay of data from one network to another network is required, the SD memory card 200 may autonomously stop transmission according to the degree of congestion of the network that is the transmission destination. At this time, the SD memory card 200 may save (and temporarily store) the data in the nonvolatile memory 260. Then, in a case in which the degree of congestion of the network that is the transmission destination decreases, the transmission of the data stored in the nonvolatile memory 260 may be resumed.

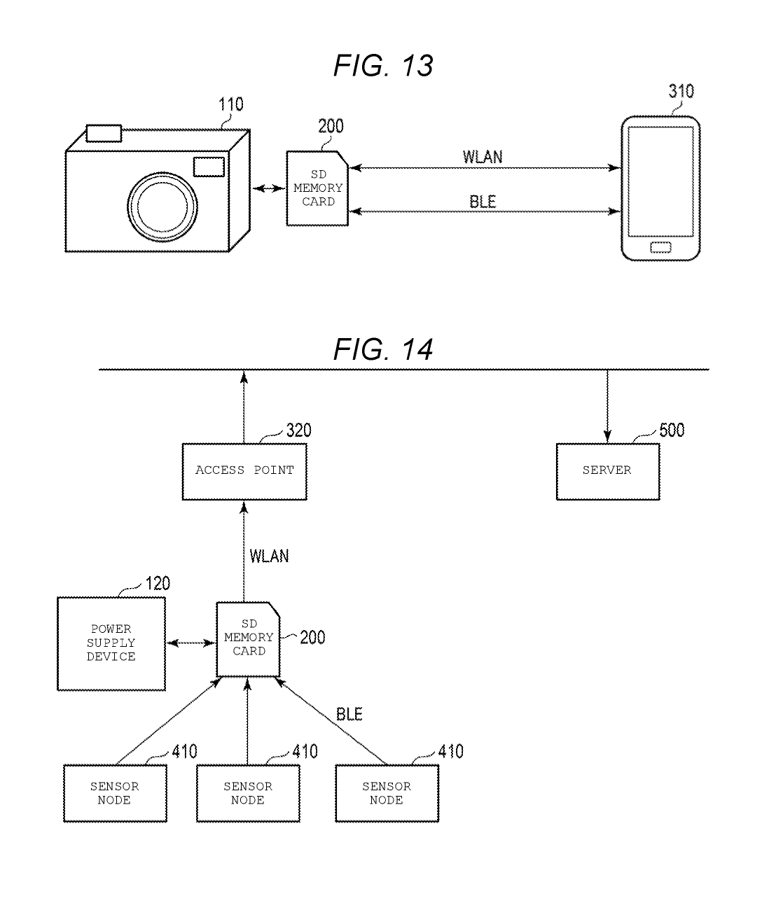

FIG. 13 is a diagram illustrating a second application example of the SD memory card 200. In the second application example, a configuration oriented toward the use for a consumer (user) is employed.

As illustrated in FIG. 13, in the second application example, the SD memory card 200 is connected to a digital camera 110 as the SD host device 100, a WLAN communication unit of a smartphone 310 as the first communication device 300, and a BLE communication unit of the same smartphone 310 as the second communication device 400.

The SD memory card 200 loaded in the digital camera 110 starts BLE communication with the smartphone 310 after power is input to the digital camera 110. On the other hand, the SD memory card 200 does not execute WLAN communication with the smartphone 310. At this time, by using an application of the smartphone 310, setting of WLAN communication of the SD memory card 200 is executed. In other words, the SD memory card 200 and the smartphone 310 are connected using only the BLE communication, and the setting of the WLAN communication of the SD memory card 200 is executed using an application of the smartphone 310 through the BLE communication. For example, the second communication controller 250 controls the setting of the WLAN communication in the first communication controller 240 according to an instruction from the smartphone 310 through the BLE communication. Accordingly, even when the content of the setting of the WLAN communication is reflected, the BLE communication is connected without any change, therefore the communication between the SD memory card 200 and the smartphone 310 is not disconnected. In addition, by using the application of the smartphone 310 through the BLE communication, not only the setting of the WLAN communication of the SD memory card 200 but also the start and the stop of the WLAN communication may be controlled.

In addition, the SD memory card 200 loaded in the digital camera 110 transmits recorded image files to the smartphone using the WLAN communication. On the other hand, the SD memory card 200 transmits properties, thumbnails, and the like of image files to the smartphone using the BLE communication. In other words, the SD memory card 200 transmits data having a large volume using the WLAN communication of high speed and high power consumption and transmits data having a small volume using the BLE of low speed and low power consumption. Accordingly, the power consumption can be reduced while the loss in the operation speed is minimized.

FIG. 14 is a diagram illustrating a third application example of the SD memory card 200. In the third application example, a configuration oriented toward the use for Internet of Things (IoT) is employed.

As illustrated in FIG. 14, in the third application example, the SD memory card 200, for example, is connected to a power supply device 120 as the SD host device 100, a WLAN access point 320 as the first communication device 300, and a plurality of sensor nodes 410 in a sensor network as the second communication device 400. Here, the second communication device 400 is not limited to the sensor node 410 but may be a beacon.

After power is input using the power supply device 120, the SD memory card 200 is connected to a higher-rank network (for example, a server 500) through the WLAN access point 320. After input of power or according to an instruction from a higher-rank network, the SD memory card 200 starts an operation as the central device of BLE communication. Accordingly, the SD memory card 200 finds a sensor node 410 that is present on the periphery thereof and is connected to the sensor node. Then, the SD memory card 200 collects data from the sensor node 410 and transmits the collected data to the higher-rank network.

In addition, the SD memory card 200 may not transmit the collected data according to the degree of congestion of the higher-rank network or the degree of importance of the collected data. In such a case, the SD memory card 200 may store the collected data in the nonvolatile memory 260.

In addition, the SD memory card 200 may store data received using the BLE communication in the nonvolatile memory 260 in a file format. In addition, the SD memory card 200 may receive and accumulate data to be transmitted using the WLAN communication by using the BLE communication until a predetermined amount of the data is collected. In such a case, after the predetermined amount of data is collected, the SD memory card 200 may start WLAN communication and transmit the collected data altogether using the WLAN communication. Accordingly, the operation time of the WLAN communication having relatively high power consumption can be shortened, and an effect of power saving can be acquired.

In addition, the data stored in a file format in the SD memory card 200 can be physically read using a function of the SD memory card 200. Accordingly, even in a case of a malfunction in at least one network of the WLAN and the BLE, data can be protected using the data accumulated in the SD memory card 200.

[Effects]

As a comparative example, an SD memory card executing WLAN communication is proposed. The WLAN communication in the SD card has relatively high power consumption. For this reason, the SD card of the comparative example, for example, shortens the lasting time of a battery of an SD host device such as a digital camera.

On the other hand, according to this embodiment, the SD memory card 200 can execute not only the WLAN communication but also the BLE communication. The BLE communication has power consumption lower than that of the WLAN communication. For this reason, by appropriately executing the BLE communication, the power consumption can be reduced.

In addition, in the comparative example, for example, the setting of the WLAN communication in the SD memory card is executed by a smartphone or the like connected using the WLAN communication. In this case, every time when the setting content of the WLAN communication is updated, the WLAN communication between the SD memory card and the smartphone is interrupted. In addition, WLAN communication needs to be connected again at that time, and accordingly, the user convenience is poor.

On the other hand, according to this embodiment, the setting of the WLAN communication in the SD memory card 200 is executed by a smartphone or the like connected using the BLE communication. Accordingly, even when the setting content of the WLAN communication is updated, the BLE communication between the SD memory card and the smartphone is not interrupted, and the problem described above can be solved.

While several embodiments according to the present disclosure have been described, such embodiments are presented as examples and are not for the purpose of limiting the scope of the present disclosure. These novel embodiments can be performed in various other forms, and various omissions, substitutions, and changes can be made therein in a range not departing from the concept of the present disclosure. These embodiments and modifications thereof belong to the scope and the concept of the present disclosure and belong to the present disclosure described in the claims and equivalent ranges thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A memory card comprising:
an interface connectable to a host device;
a nonvolatile memory;
a memory control circuitry for the nonvolatile memory;
an antenna for radio communication with a first communication device via a first communication system and for radio communication with a second communication device via a second communication system different from the first communication system;
a first communication control circuitry configured to control the radio communication via the first communication system; and
a second communication control circuitry configured to control the radio communication via the second communication system,
wherein the first communication control circuitry and the second communication control circuitry preferentially operate the radio communication using the antenna via the second communication system over the radio communication using the antenna via the first communication system.

2. The memory card according to claim 1,
wherein the radio communication via the first communication system is executed in any period, and
the radio communication via the second communication system is executed in a predetermined period.

3. The memory card according to claim 1,
wherein the first communication system is a CSMA system, and
the second communication system is a frequency hopping system.

4. The memory card according to claim 1,
wherein the radio communication via the first communication system is WLAN communication, and
the radio communication via the second communication system is BLE communication.

5. The memory card according to claim 1,
wherein the interface communicates with the host device via an SD standard protocol.

6. The memory card according to claim 1,
wherein the radio communication via the first communication system and the radio communication via the second communication system use the antenna in a time division manner.

7. The memory card according to claim 1,
wherein the second communication controller controls the radio communication with the first communication device via the first communication system according to an instruction from the second communication device.

8. The memory card according to claim 7, wherein the second communication controller controls the radio communication with the first communication device via the first communication system by sending a signal for selecting the radio communication via the first communication system or the radio communication via the second communication system to the first communication controller.

9. The memory card according to claim 1,
wherein a packet from the second communication device is transmitted to the first communication device through the antenna, the first communication controller, and the second communication controller.

10. The memory card according to claim 1,
wherein the radio communication via the first communication system and the radio communication via the second communication system are controlled according to an SD extension command received from the host device.

11. A method of controlling a memory card that comprises an interface connectable to a host device, a nonvolatile memory, and an antenna for radio communication with a first communication device via a first communication system and for radio communication with a second communication device via a second communication system different from the first communication system, the method comprising:
preferentially selecting radio communication using the antenna to be via the second communication system rather than via the first communication system.

12. The method according to claim 11, further comprising:
executing the radio communication via the first communication system in any period, and
executing the radio communication via the second communication system in a predetermined period.

13. The method according to claim 11,
wherein the first communication system is a CSMA system, and
the second communication system is a frequency hopping system.

14. The method according to claim 11,
wherein the radio communication via the first communication system is WLAN communication, and
the radio communication via the second communication system is BLE communication.

15. The method according to claim 11,
wherein the interface communicates with the host device via an SD standard protocol.

16. The method according to claim 11,
wherein the radio communication via the first communication system and the radio communication via the second communication system uses the antenna in a time division manner.

17. The method according to claim 11, further comprising:
controlling the radio communication with the first communication device via the first communication system according to an instruction from the second communication device.

18. The method according to claim 17, further comprising:
controlling the radio communication with the first communication device via the first communication system according to a signal for selecting the radio communication via the first communication system or the radio communication via the second communication system.

19. The method according to claim 11,
wherein a packet from the second communication device is transmitted to the first communication device through the antenna, a first circuitry that controls the radio communication via the first communication system, and a second circuitry that controls the radio communication via the second communication system.

20. The method according to claim 11,
wherein the radio communication via the first communication system and the radio communication via the second communication system are controlled according to an SD extension command received from the host device.
